(19) United States
(12) Patent Application Publication
(10) Pub. No.: US 2026/0358845 A1
(43) Pub. Date: Nov. 12, 2026

(54) SAFE OPERATING AREA IMPROVEMENT FOR POWER CONVERTERS

(71) Applicant: TEXAS INSTRUMENTS INCORPORATED, Dallas, TX (US)

(72) Inventors: Kishore Peetala, Vizianagaram (IN); Vinod Menezes, Bangalore (IN)

(21) Appl. No.: 19/200,018

(22) Filed: May 6, 2025

(51) Int. Cl. G05F 1/571; G05F 1/575; G05F 1/59

(52) U.S. Cl. CPC G05F 1/571; G05F 1/575; G05F 1/59

(57) ABSTRACT

Described examples include a circuit that includes a control circuit having first and second outputs. A first transistor has a terminal. A second transistor has a terminal coupled to the terminal of the first transistor, a bulk, and a control terminal. The first and second transistors are coupled in series between an input voltage terminal of the circuit and an output voltage terminal of the circuit, and the control terminal is coupled to the first output of the control circuit. A switch has a first terminal coupled to the terminal of the second transistor, a second terminal coupled to the bulk, and a control terminal coupled to the second output of the control circuit. A resistor has a first terminal coupled to the terminal of the second transistor, and a second terminal coupled to the bulk.

### BACKGROUND

This description relates to power converters including low dropout voltage regulators (LDOs). LDO circuits usually include a pass device, such as a field effect transistor (FET) or a bipolar junction transistor (BJT), in an output voltage drive stage. This pass device may become damaged if the device operates outside of its safe operating area (SOA). Operation outside the SOA can occur if the pass device is operating at a relatively high power.

High power operation occurs in the pass device when a higher voltage (e.g. >10V) is applied across the pass device (e.g. between the input voltage terminal and the output voltage terminal), or if the pass device has to provide a relatively high load current. Higher voltage across the pass device and a higher current through the pass device can result in a power dissipation in the pass device that exceeds its SOA, potentially damaging the pass device.

Voltage regulators may include a current limit protection circuit to limit the current through the pass element to a particular current level. However, even with a current limit circuit in the LDO, the pass device may experience a secondary breakdown at high drain-to-source voltage (V_{DS}) due to the Spirito effect resulting in operation outside the SOA and damage to the device.

### SUMMARY

A circuit includes a control circuit having first and second outputs. A first transistor has a terminal. A second transistor has a terminal, a bulk, and a control terminal. The terminal of the second transistor is coupled to the terminal of the first transistor. The first and second transistors are coupled in series between an input voltage terminal of the circuit and an output voltage terminal of the circuit, and the control terminal is coupled to the first output of the control circuit.

A switch has first and second terminals and a control terminal. The first terminal of the switch is coupled to the terminal of the second transistor. The second terminal of the switch is coupled to the bulk. The control terminal of the switch is coupled to the second output of the control circuit. A resistor has first and second terminals. The first terminal of the resistor is coupled to the terminal of the second transistor, and the second terminal of the resistor is coupled to the bulk.

In a second example, a circuit includes an amplifier having a reference input, a second input, and an output. The second input of the amplifier is coupled to an output voltage terminal of the circuit. A control circuit has first and second inputs and first and second outputs. The first input of the control circuit is coupled to an input voltage terminal of the circuit, and the second input of the control circuit is coupled to the output voltage terminal. A first transistor has first and second terminals and a control terminal. The first terminal of the transistor is coupled to the input voltage terminal, and the control terminal is coupled to the output of the amplifier.

A second transistor has first and second terminals, a bulk, and a control terminal. The first terminal is coupled to the second terminal of the first transistor. The second terminal of the second transistor is coupled to the output voltage terminal, and the control terminal is coupled to the first output of the control circuit. A third transistor has first and second terminals, a bulk, and a control terminal. The second terminal of the third transistor is coupled to the output voltage terminal, and the control terminal of the third transistor is coupled to the first output of the control circuit.

A first switch has first and second terminals and a control terminal. The first terminal of the first switch is coupled to the first terminal of the second transistor. The second terminal of the first switch is coupled to the bulk of the second transistor. The control terminal of the first switch is coupled to the second output of the control circuit. A second switch has first and second terminals and a control terminal. The first terminal of the second switch is coupled to the first terminal of the third transistor. The second terminal of the second switch is coupled to the bulk of the third transistor. The control terminal of the second switch is coupled to the second output of the control circuit.

A first resistor has first and second terminals. The first terminal of the first resistor is coupled to the first terminal of the second transistor, and the second terminal of the first resistor is coupled to the bulk of the second transistor. A second resistor has first and second terminals. The first terminal of the second resistor is coupled to the first terminal of the third transistor, and the second terminal of the second resistor is coupled to the bulk of the third transistor.

In a third example, a circuit includes an amplifier having first and second inputs and an output. The first input is coupled to a feedback voltage terminal, and the second input is coupled to a reference voltage terminal. A buffer circuit has an input and an output. The input of the buffer circuit is coupled to the output of the amplifier. A control circuit has first and second inputs and first and second outputs. The first input of the control circuit is coupled to an input voltage terminal of the circuit, and the second input is coupled to an output voltage terminal of the circuit.

A first transistor has first and second terminals and a control terminal. The first terminal is coupled to the output voltage terminal of the circuit, and the control terminal is coupled to the output of the buffer circuit. A second transistor has first and second terminals, a bulk, and a control terminal. The first terminal of the second transistor is coupled to the second terminal of the first transistor. The second terminal of the second transistor is coupled to the input voltage terminal of the circuit, and the control terminal is coupled to the first output of the control circuit.

A switch is coupled between the first terminal of the second transistor and the bulk, and has a control terminal that is coupled to the second output of the control circuit. A resistor is coupled between the first terminal of the second transistor and the bulk.

### BRIEF DESCRIPTION OF THE DRAWINGS

FIG. 1(a) shows an example schematic diagram for a field effect transistor (FET).

FIG. 1(b) shows an example safe operating area diagram for the FET shown in FIG. 1(a).

FIG. 2 shows a schematic diagram for an example LDO using an NMOS FET as a pass device and having reverse current protection (RCP).

FIG. 3 shows an example plot of drain current (I_{D}) as a function of gate-to-source voltage (V_{GS}) over a temperature range for the pass FET shown in FIG. 2.

FIG. 4 shows a schematic diagram for an example voltage regulator LDO circuit including a pass transistor circuit with RCP protection and using degeneration.

FIG. 5 shows a schematic diagram for an example LDO circuit having RCP protection, using degeneration, and having distributed transistors.

FIG. 6 shows a schematic diagram for an example pass transistor circuit with degeneration illustrating the implementation of distribution.

FIG. 7 shows a schematic diagram for an example LDO circuit having RCP protection, using degeneration, and having a smooth switching circuit to help counteract switching effects.

### DETAILED DESCRIPTION

In this description, the same reference numbers depict same or similar (by function and/or structure) features. The drawings are not necessarily drawn to scale.

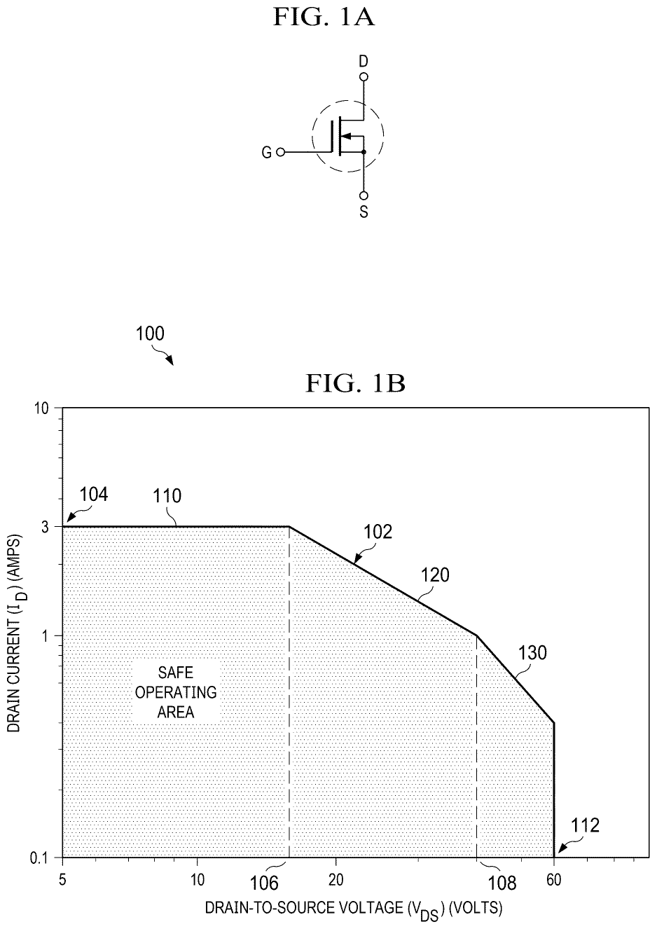

Low Dropout voltage converters (LDOs) usually include a pass device such as a field effect transistor (FET) or a bipolar junction transistor (BJT) in the output voltage drive stage. FIG. 1(a) shows an example schematic diagram for a FET. Current flows between the drain and source of the FET in response to a voltage difference between the gate and source of the FET. The pass device carries the current (i.e. drain current) required to be supplied at the output voltage terminal. The pass device may become damaged if it operates outside of its safe operating area (SOA), which can occur if the pass device is operating at a relatively high power. The safe operating area (SOA) provides an indication of the amount of power a device can safely handle without failing by specifying a maximum current flowing through the device at a particular voltage across the device.

In many cases, the pass device is coupled between an input voltage terminal and an output voltage terminal of the LDO. High power operation occurs in the pass device when a higher voltage (e.g. >10V) is applied across the pass device, or if the pass device has to provide a relatively high load current to the output voltage terminal. If a relatively high voltage is applied across the pass device or a relatively high current flows through the pass device, the power dissipation in the pass device may exceed its SOA, potentially resulting in failure of the pass device.

Voltage regulators, such as LDOs, may include a current limit protection circuit to limit the current flowing through the pass device at a particular current level. However, even if a current limit circuit is used in an LDO, a secondary breakdown can occur in a pass FET if the drain-to-source voltage (V_{DS}) takes the power dissipation of the FET outside of its SOA. This secondary breakdown is due to the Spirito Effect. In this description, the pass device is described as a FET, but the FETs can be replaced with BJTs by substituting a base for the gate, an emitter for the source, and a collector for the drain of the transistor in each case. Also, an n-channel FET may be interchanged with a p-channel FET in this description.

FIG. 1(b) shows an example safe operating area (SOA) diagram 100 for a FET such as the FET in FIG. 1(a). The x-axis of diagram 100 represents the drain-to-source voltage (V_{DS}) of the FET. The y-axis of diagram 100 represents the drain current (I_{D}) of the FET. Curve 102 represents the safe operating area (SOA) characteristic of the FET, or the drain current that allows operation of the FET within its SOA at a particular V_{DS}. SOA characteristic 102 includes a first section 110, a second section 120, and a third section 130.

In section 110, the safe drain current of SOA characteristic 102 remains constant at a maximum safe current level 104 as the V_{DS} increases from zero until the V_{DS} reaches voltage level 106. The maximum safe current level 104 is influenced by the die size or geometry of the FET among other factors. Under ideal conditions, the safe drain current would remain constant at the maximum safe current level 104 for increasing V_{DS} voltages from zero to the maximum V_{DS} voltage level 112. In the ideal case, SOA characteristic 102 would be rectangular. Operating at any combination of drain current and V_{DS} voltage that is above or to the right of SOA characteristic 102 is a risk for the safety of the device.

In section 120, the safe drain current of SOA characteristic 102 begins decreasing with increasing V_{DS} at a first slope between V_{DS} voltage level 106 and V_{DS} voltage level 108. This decrease in safe drain current of SOA characteristic 102 is due mainly to thermal transfer from self-heating of the device. In section 130, the safe drain current of SOA characteristic 102 begins decreasing with increasing V_{DS} at a steeper slope than the first slope between V_{DS} voltage level 108 and V_{DS} voltage level 112. The higher rate of decrease in safe drain current of SOA characteristic 102 is due to a secondary breakdown effect known as the Spirito effect. There is no safe drain current level for operating at V_{DS} voltages higher than the maximum V_{DS} voltage level 112.

The Spirito effect is a thermal instability that can occur in a FET, particularly when operating in linear mode. The Spirito effect is caused by uneven current distribution across the silicon die of the transistor in which a hotter region draws more current and dissipates more power. The higher power dissipation further increases its temperature leading to a situation where the temperature of the transistor continues to increase uncontrollably, causing localized areas of high temperature and potential device failure.

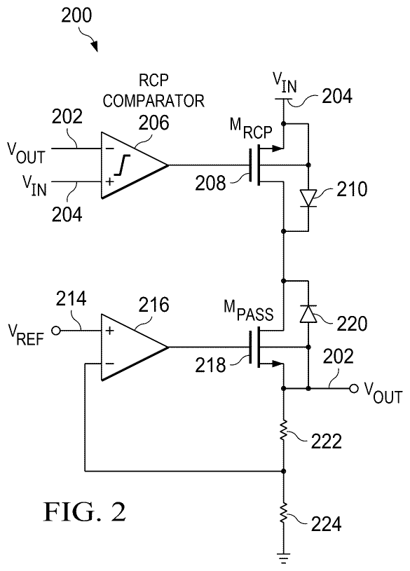

FIG. 2 shows a schematic diagram for an example LDO 200 using an n-channel FET M_{PASS} 218 as a pass device and having reverse current protection (RCP). In at least one example of LDO 200, n-channel FET M_{PASS} 218 is replaced with a p-channel FET. The LDO 200 includes an amplifier 216, resistors 222 and 224, a comparator 206, an RCP FET M_{RCP} 208, a reference voltage source terminal 214, and pass FET M_{PASS} 218. The input voltage terminal V_{IN} 204 provides an input voltage V_{IN}. The output of LDO 200 is a voltage V_{OUT} which is provided at output voltage terminal V_{OUT} 202.

Resistors 222 and 224 form a voltage divider circuit and provide a voltage proportional to the voltage at the output voltage terminal V_{OUT} 202 to a first terminal of amplifier 216. A reference voltage source provides a reference voltage V_{REF} to a second terminal of amplifier 216. The output of amplifier 216 is coupled to the gate of pass FET M_{PASS} 218 and provides a voltage proportional to the difference between reference voltage V_{REF} and the voltage provided at the center-tap of the voltage divider circuit formed by resistors 222 and 224. In this example, amplifier 216 is implemented as an error amplifier.

A first input of RCP comparator 206 is coupled to the output voltage terminal V_{OUT} 202. A second input of RCP comparator 206 is coupled to the input voltage terminal V_{IN} 204. The output of RCP comparator 206 is coupled to the gate of RCP FET M_{RCP} 208 and turns RCP FET M_{RCP} 208 on or off depending on whether the voltage at output voltage terminal V_{OUT} 202 is higher or lower than the voltage at the input voltage terminal V_{IN} 204. In this example, comparator 206 has internal hysteresis to minimize oscillations. Such internal hysteresis may not be included in other examples.

The source of RCP FET M_{RCP} 208 is coupled to the input voltage terminal V_{IN} 204, and the drain of RCP FET M_{RCP} 208 is coupled to the drain of pass FET M_{PASS} 218. RCP FET M_{RCP} 208 includes an inherent parasitic diode 210 coupled between its bulk and drain. The source of pass FET M_{PASS} 218 is coupled to the output voltage terminal V_{OUT} 202, and the drain of pass FET M_{PASS} 218 is coupled to the drain of RCP FET M_{RCP} 208. Pass FET M_{PASS} 218 includes an inherent parasitic diode 220 coupled between its bulk and drain.

The pass FET M_{PASS} 218 drops all the voltage between the input voltage terminal V_{IN} 204 and the output voltage terminal V_{OUT} 202. A reverse current protection (RCP) circuit that includes RCP FET M_{RCP} 208 is inserted between the input voltage terminal V_{IN} 204 and the drain of pass FET M_{PASS} 218. RCP FET M_{RCP} 208 is usually operated in the linear region and acts as a resistor whose resistance is controlled by the voltage difference between its gate and source. RCP FET M_{RCP} 208 can be turned off to avoid reverse currents flowing from the output voltage terminal V_{OUT} 202 to the input voltage terminal V_{IN} 204.

If a system power glitch occurs causing the input voltage to suddenly drop to a low voltage (i.e. 0 or 1V), current may flow from an output capacitor (not shown) to the input voltage terminal V_{IN} 204. If no reverse current protection is provided between the input voltage terminal V_{IN} 204 and the drain of pass FET M_{PASS} 218, a reverse current flows from the output voltage terminal V_{OUT} 202 to the input voltage terminal V_{IN} 204. The reverse current protection is provided by the inherent parasitic diodes 210 and 220 from the back-to-back FETs M_{RCP} 208 and M_{PASS} 218, respectively. In this example RCP FET M_{RCP} 208 and pass FET M_{PASS} 218 are each n-channel FETs. However, the RCP circuit works equally well if RCP FET M_{RCP} 208 and pass FET M_{PASS} 218 are each p-channel FETs.

In many cases, RCP FET M_{RCP} 208 and pass FET M_{PASS} 218 are sized equally and have equal dropout voltages. Pass FET M_{PASS} 218 usually operates in saturation and dissipates significantly higher power than RCP FET M_{RCP} 208, which usually operates in triode mode. So, the safe operating area (SOA) of pass FET M_{PASS} 218 is a larger concern when operating at higher power.

In an example case, the input voltage terminal V_{IN} 204 is at 20 V and the output voltage terminal V_{OUT} 202 is shorted to ground in a short circuit fault event. In this example, both the RCP FET M_{RCP} 208 and pass FET M_{PASS} 218 are sized for a dropout voltage of 250 mV. The RCP FET M_{RCP} 208 acts as a resistor and drops 250 mV, so 19.75 V is applied across pass FET M_{PASS} 218. Because a fault event is sensed, the current limit of the LDO engages and limits the current. Assuming the LDO current limit is set at 2 A, that current flows through both the RCP FET M_{RCP} 208 and the pass FET M_{PASS} 218.

In this case, the RCP FET M_{RCP} 208 has a power dissipation of 250 mV*2 A or 0.5 W, while the pass FET M_{PASS} 218 has a power dissipation of 20V*2 A or 40 W. Thus, the pass FET M_{PASS} 218 has a power dissipation that is 80 times higher than the RCP FET M_{RCP} 208 power dissipation, but these two FETs have the same silicon area. So, the pass FET M_{PASS} 218 is likely to have an SOA issue. But RCP FET M_{RCP} 208 and pass FET M_{PASS} 218 are protected from reverse currents when they are both turned off. In response to the input voltage dropping low, the output of RCP comparator 206 and the output of amplifier 216 each go low, turning off both FETs. Parasitic diode 220 is turned on and inherent parasitic diode 210 is turned off, so no reverse current can flow through the pass FET M_{PASS} 218 and the RCP FET M_{RCP} 208.

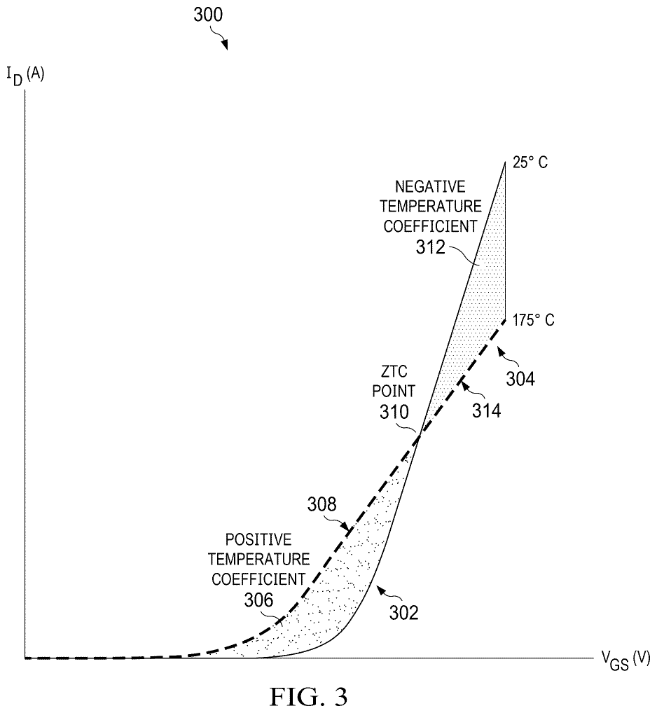

FIG. 3 shows a plot of drain current as a function of gate-to-source voltage over a temperature range for an example FET. The x-axis of plot 300 represents the gate-to-source voltage (V_{GS}) of the example FET measured in volts. The y-axis of plot 300 represents the drain current (I_{D}) of the example FET measured in amps. Curve 302 represents a plot of I_{D} as a function of V_{GS} at a temperature of 25 °C. Curve 304 represents a plot of I_{D} as a function of V_{GS} at a temperature of 175 °C.

In region 306 of plot 300, the distance 308 between I_{D} at 25 °C and I_{D} at 175 °C at a given V_{GS} is positive, producing a positive temperature coefficient. In region 312 of plot 300, the distance 314 between I_{D} at 25 °C and I_{D} at 175 °C at a given V_{GS} is negative, producing a negative temperature coefficient. The point where curve 302 and curve 304 meet is the zero temperature coefficient (ZTC) point 310 where temperature does not affect I_{D}.

With a constant V_{GS}, as the temperature rises, the output current of the device decreases because the electrical resistance increases as the temperature rises, causing the current to decrease. A decrease in current can be advantageous if power consumption is a concern. As an example, if a fault event occurs in which the output voltage terminal is shorted to ground, and the V_{GS} is higher than the V_{GS} at the ZTC point, the temperature of the device increases rapidly due to the increased power consumption. Because the V_{GS} is higher than the V_{GS} at the ZTC point, the current decreases as the temperature rises due to operating in the negative temperature coefficient region 312.

The opposite effect occurs when operating at a V_{GS} that is below the ZTC point. As the temperature increases, the current is higher at a higher temperature compared to the current at a lower temperature. As an example, if the power dissipation is 20 W at 25 °C, the temperature may rise to 125 °C, for example, due to the power dissipation. In response to the temperature rising, the current increases. The higher current produces a higher power dissipation, and the higher power dissipation further increases the current. This is a positive feedback loop caused by the positive temperature coefficient, which continues until the FET fails. The Spirito effect causes a positive temperature coefficient that produces a positive feedback loop that leads to runaway current until the FET is destroyed.

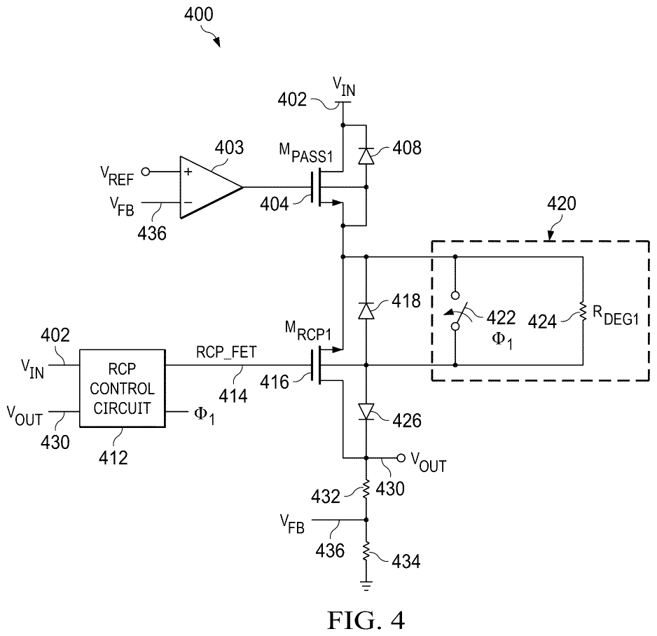

The use of degeneration can help limit the Spirito effect by transforming positive feedback to negative feedback. Degeneration usually includes adding a resistor connected between the source of a transistor and a ground terminal. Examples of the present description include a different and adaptive connectivity of a resistor to facilitate degeneration, as illustrated in FIGS. 4, 5, and 7. FIG. 4 shows a schematic diagram for an example voltage regulator LDO circuit 400 including a pass transistor circuit with RCP protection and using degeneration. LDO circuit 400 includes RCP control circuit 412, amplifier 403, transistor M_{PASS1} 404, transistor M_{RCP1} 416, switch 422, and resistors 432, 434 and R_{DEG1} 424.

Amplifier 403 has a first input coupled to a reference voltage terminal providing a reference voltage V_{REF}. A second input of amplifier 403 is coupled to a voltage feedback terminal V_{FB} 436. The voltage at voltage feedback terminal V_{FB} 436 is proportional to the voltage at the output voltage terminal V_{OUT} 430, and is taken at the center tap of a voltage divider formed by resistors 432 and 434 that are coupled in series between the output voltage terminal V_{OUT} 430 and a ground terminal. The output of amplifier 403 provides a voltage proportional to the difference in voltage between the voltage feedback terminal V_{FB} 436 and the reference voltage V_{REF}.

Transistor M_{PASS1} 404 is coupled between an input voltage terminal V_{IN} 402 and the source of transistor M_{RCP1} 416. The gate of transistor M_{PASS1} 404 is coupled to the output of amplifier 403. In at least one example, transistor M_{PASS1} 404 is an n-channel FET that includes an inherent parasitic diode 408 connected between the bulk and drain of the FET. A second inherent parasitic diode between the bulk and source of transistor M_{PASS1} 404 is internally shorted, which is a common practice in many FETs. This is shown as a wired connection between the bulk and source of transistor M_{PASS1} 404.

Transistor M_{RCP1} 416 is coupled between the source of transistor M_{PASS1} 404 and an output voltage terminal V_{OUT} 430. In at least one example, transistor M_{RCP1} 416 is an n-channel FET that includes an inherent parasitic diode 418 connected between the bulk and drain of the FET. A second inherent parasitic diode 426 is connected between the bulk and source of transistor M_{RCP} 416. The anodes of the inherent parasitic diodes 418 and 426 are connected to the bulk of transistor M_{RCP1} 416.

The gate of transistor M_{RCP1} 416 is coupled to a first output of RCP control circuit 412. A first input of RCP control circuit 412 is coupled to the input voltage terminal V_{IN} 402. A second input of RCP control circuit 412 is coupled to the output voltage terminal V_{OUT} 430. RCP control circuit 412 compares the voltage at the input voltage terminal V_{IN} 402 to the voltage at the output voltage terminal V_{OUT} 430 and turns off transistor M_{RCP1} 416 if the difference between the two voltages is higher than a particular limit.

Degeneration circuit 420 is coupled between the bulk of transistor M_{RCP1} 416 and the source of transistor M_{RCP1} 416. Degeneration circuit 420 includes resistor R_{DEG1} 424 and switch 422. Resistor R_{DEG1} 424 is coupled in parallel with switch 422 between the bulk and the source of transistor M_{RCP1} 416. In most cases, resistor R_{DEG1} 424 has a relatively small resistance to avoid a large voltage drop. RCP control circuit 412 provides a second output signal Φ₁ that controls switch 422. If switch 422 is closed, no current flows through resistor R_{DEG1} 424 and inherent parasitic diode 418 of transistor M_{RCP1} 416. If switch 422 is open, transistor M_{RCP1} 416 is turned off and the inherent parasitic diode 418 of transistor M_{RCP1} 416 is reverse biased and does not affect the current flow from the input voltage terminal V_{IN} 402 to the output voltage terminal V_{OUT} 430. So, virtually all the current flows through resistor R_{DEG1} 424.

LDO circuit 400 produces a negative current feedback effect using a current-controlling mechanism that includes degeneration resistor R_{DEG1} 424. If the current through degeneration resistor R_{DEG1} 424 increases, the voltage dropped across degeneration resistor R_{DEG1} 424 increases. The increase in voltage drop across degeneration resistor R_{DEG1} 424 decreases the V_{GS} of transistor M_{PASS1} 404, which decreases the current through transistor M_{PASS1} 404. When the current through degeneration resistor R_{DEG1} 424 increases, this acts as negative feedback by increasing the voltage drop across degeneration resistor R_{DEG1} 424 which is used to counteract the positive temperature coefficient of the Spirito effect. Degeneration protects the device from current runaway by changing the positive current feedback to negative current feedback.

In pass transistor circuits having reverse current protection, the RCP FET is usually connected to the input voltage terminal (i.e. “on top”) and the pass FET is usually connected to the output voltage terminal (i.e. “on bottom”). However, a significant amount of area may be wasted in this configuration because the size of the RCP FET is usually equal to the size of the pass FET and is not used effectively to dissipate power but only to block currents. In LDO circuit 400, the FETs are reversed from the usual configuration so that the pass FET M_{PASS1} 404 is connected to the input voltage terminal V_{IN} 402, and the RCP FET M_{RCP1} 416 is connected to the output voltage terminal V_{OUT} 430. Inherent parasitic diodes 418 and 426 from the FETs are still back-to-back so that if one of the parasitic diodes is forward biased, the other parasitic diode is reverse biased.

The voltage difference between the input voltage terminal V_{IN} 402 and the output voltage terminal V_{OUT} 430 is monitored. If that voltage difference exceeds a particular limit (e.g. 10V), the RCP FET M_{RCP1} 416 is turned off. Instead of shorting the bulk of RCP FET M_{RCP1} 416 to the source of RCP FET M_{RCP1} 416 as is done in most FETs, a switch 422 is instead connected between the bulk and source of RCP FET M_{RCP1} 416. Switch 422 is opened if the voltage difference between the voltages at the input voltage terminal V_{IN} 402 and the output voltage terminal V_{OUT} 430 exceeds the particular limit. When transistor M_{RCP1} 416 is turned off, switch 422 is opened and the bulk is connected to the source of transistor M_{RCP1} 416 through degeneration resistor R_{DEG1} 424.

In LDO circuit 400, a switch and a resistor are connected in parallel with the inherent parasitic diode between the bulk and the source of the FET instead of the bulk being shorted to the source as is currently done in most FETs. When the switch is open, the parasitic diode and the resistor are connected in parallel. The resistor provides a low resistance path for current to flow, so no current flows through the parasitic diode which is reverse biased, and a voltage drop proportional to the current occurs across the resistor providing negative current feedback.

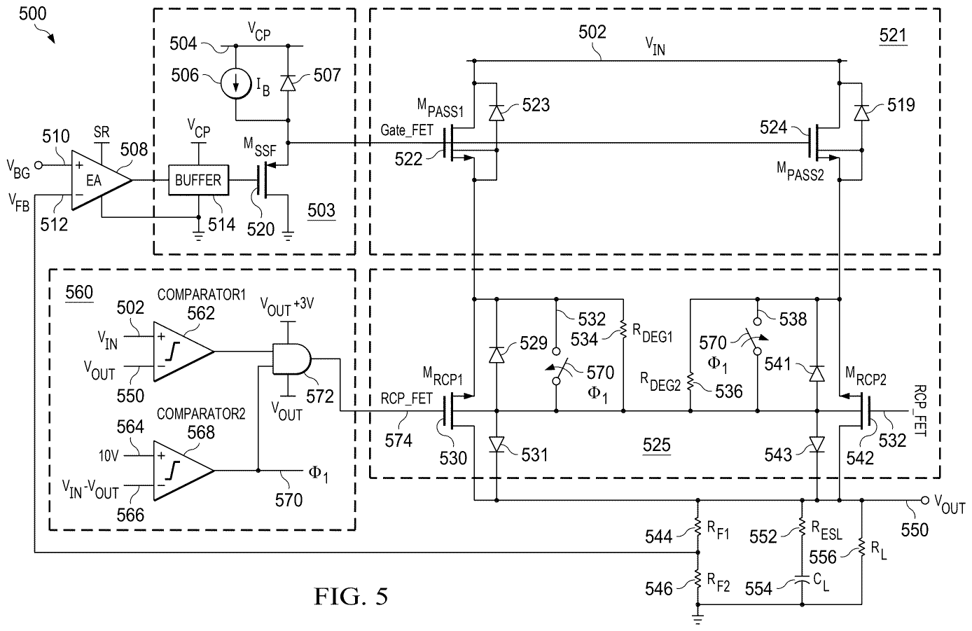

FIG. 5 shows a schematic diagram for an example LDO circuit 500 having RCP protection, using degeneration, and having distributed transistors. LDO circuit 500 includes amplifier 508, super source follower circuit 503, pass FET 521, RCP control circuit 560, and RCP circuit 525. Amplifier 508 has a first input coupled to a reference voltage source V_{BG} 510. A second input of amplifier 508 is coupled to a feedback voltage terminal V_{FB} 512. The output of amplifier 508 provides a signal proportional to the difference between the voltages at the feedback voltage terminal V_{FB} 512 and the reference voltage source V_{BG} 510, and is coupled to the input of super source follower circuit 503.

Super source follower circuit 503 includes buffer circuit 514 which has an input coupled to the output of amplifier 508. Buffer circuit 514 can be a unity gain amplifier having an analog voltage input and an analog voltage output. In at least one case, buffer circuit 514 provides an adaptive bias current to the gate of transistor M_{SSF} 520 that adaptively changes with and is proportional to a load current provided at the output voltage terminal V_{OUT} 550.

Super source follower circuit 503 further includes current source I_{B} 506, diode 507, and transistor M_{SSF} 520. Super source follower circuit 503 functions as a buffer circuit between the output of amplifier 508 and the gate of pass FET 521. Super source follower circuit 503 provides unity gain with negative feedback through transistor M_{SSF} 520 and low output resistance. In other cases, super source follower circuit 503 may be replaced by a circuit having a different circuit topology performing essentially the same function. Current source I_{B} 506 is coupled between a terminal 504, which is coupled to a charge pump voltage source that provides a voltage V_{CP}, and the source of transistor M_{SSF} 520. The drain of transistor M_{SSF} 520 is coupled to a ground terminal. Diode 507 is a parasitic diode of current source I_{B} 506.

RCP control circuit 560 includes comparator 562, comparator 568, and logic circuit 572, which in at least one case is an AND gate. In this example, comparators 562 and 568 have internal hysteresis to minimize oscillations. Such internal hysteresis may not be included in other examples. A first input of comparator 562 is coupled to the input voltage terminal V_{IN} 502. A second input of comparator 562 is coupled to the output voltage terminal V_{OUT} 550. A first input of comparator 568 is coupled to a threshold voltage terminal 564, which in at least one case is a 10V voltage source, but could be at a different voltage in other cases.

A second input of comparator 568 is coupled to the output terminal of an amplifier (not shown) that provides a difference voltage signal V_{IN}−V_{OUT} 566 that represents the voltage difference between the input voltage terminal V_{IN} 502 and the output voltage terminal V_{OUT} 550. A first input of logic circuit 571 is coupled to the output of comparator 562, and a second input of logic circuit 571 is coupled to the output of comparator 568. The output of logic circuit 572 provides the control signal RCP_FET 570.

The output of super source follower circuit 503 is coupled to the control terminal of pass FET 521, which includes distributed FETs M_{PASS1} 522 and M_{PASS2} 524. In at least one case, FETs M_{PASS1} 522 and M_{PASS2} 524 are n-channel FETs, but could be p-channel FETs in other cases. The drains of transistor M_{PASS1} 522 and transistor M_{PASS2} 524 are each coupled to the input voltage terminal V_{IN} 502. The source of transistor M_{PASS1} 522 is coupled to the source of FET M_{RCP1} 530. The source of transistor M_{PASS2} 524 is coupled to the source of FET M_{RCP2} 542. The gates of transistor M_{PASS1} 522 and transistor M_{PASS2} 524 are each coupled to the source of transistor M_{SSF} 520.

The output of RCP control circuit 560 is coupled to the control terminal of RCP circuit 525, which includes distributed FETs M_{RCP1} 530 and M_{RCP2} 542. In at least one case, FETs M_{RCP1} 530 and M_{RCP2} 542 are n-channel FETs, but could be p-channel FETs in other cases. The drains of transistor M_{RCP1} 530 and transistor M_{RCP2} 542 are each coupled to the output voltage terminal V_{OUT} 550. The source of transistor M_{RCP1} 530 is coupled to the source of FET M_{PASS1} 522. The source of transistor M_{RCP2} 542 is coupled to the source of FET M_{PASS2} 524. The gates of transistor M_{RCP1} 530 and transistor M_{RCP2} 542 are each coupled to the output of logic circuit 572.

Transistor M_{RCP1} 530 has a first inherent parasitic diode 529 between its bulk and its source, and has a second inherent parasitic diode 531 between its bulk and its drain. Transistor M_{RCP2} 542 has a first inherent parasitic diode 541 between its bulk and its source, and has a second inherent parasitic diode 543 between its bulk and its drain. Switch 532 is coupled between the bulk and the source of transistor M_{RCP1} 530 and is controlled by a signal Φ1 570 provided by the output of comparator 568. Degeneration resistor R_{DEG1} 534 is coupled in parallel with switch 532. Switch 538 is coupled between the bulk and the source of transistor M_{RCP2} 542 and is controlled by the signal Φ1 570. Degeneration resistor R_{DEG2} 536 is coupled in parallel with switch 538.

Pass FET 521 includes distributed FETs M_{PASS1} 522 and M_{PASS2} 524, and RCP circuit 525 includes distributed FETs M_{RCP1} 530 and M_{RCP2} 542. FET M_{PASS1} 522 has a first inherent parasitic diode between its bulk and its source that is shorted out, and has a second inherent parasitic diode 523 between its bulk and its drain. FET M_{PASS2} 524 has a first inherent parasitic diode between its bulk and its source that is shorted out, and has a second inherent parasitic diode 519 between its bulk and its drain.

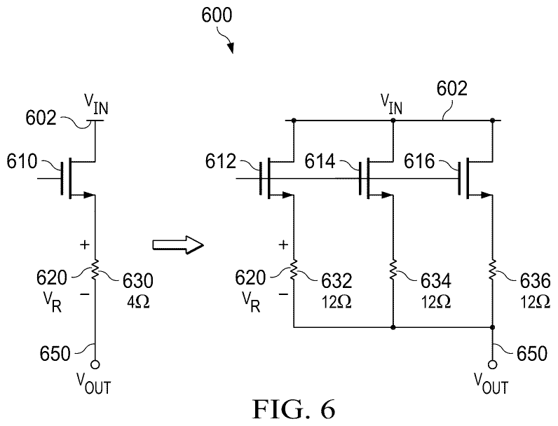

Distribution of FETs can help to provide improvement in the SOA of a FET. Distribution is distributing a single larger FET into N smaller FETs with each smaller FET having an area 1/N times the area of the larger FET. The respective sources and drains of each of the smaller FETs are connected together to effectively form a single FET unit from the multiple separate FET units. FIG. 6 shows a schematic diagram for an example pass transistor circuit 600 with degeneration illustrating the implementation of distribution.

Transistor 610 is coupled between input voltage terminal VIN 602 and a first terminal of degeneration resistor 630. The second terminal of degeneration resistor 630 is coupled to the output voltage terminal V_{OUT} 640. The voltage dropped across degeneration resistor 630 is V_{R} 620. Transistor 610 can be replaced by three smaller transistors 612, 614, and 616. Each of the respective transistors 612, 614, and 616 has an area that is one-third of the area of transistor 610. In this case, N is three, but in other cases N could be chosen as any other number. Greater benefit can be obtained by choosing a larger number for N.

If transistor 610 is replaced with three identical transistors each having one-third the area of transistor 610, then degeneration resistor 630 is replaced with three degeneration resistors 632, 634, and 636, each having a resistance three times the resistance of degeneration resistor 630. If this is done, each of the transistors 612, 614, and 616 carries the same current, and the current carried is one-third of the current carried by transistor 610, so that the total current carried in transistors 612, 614, and 616 is the same as the current carried in transistor 610.

Even though transistors 612, 614, and 616 each have the same respective area, there can be mismatch between the respective transistors due to process and other variables. If degeneration resistors 632, 634, and 636 are not present and the respective sources of transistors 612, 614, and 616 are each connected directly to the output voltage terminal V_{OUT} 640, one of transistors 612, 614, and 616 may carry as much as 40% higher current compared to another of the transistors due to mismatch between the transistors, which can be particularly pronounced in high voltage transistors.

Degeneration resistors 632, 634, and 636 can help to reduce mismatch significantly. The resistance of each of the degeneration resistors increases proportionally to the number N of distributed transistors. With the same V_{DS} across the pass transistor, the current through each distributed transistor is decreased by a factor of N, which can help avoid SOA violations. With the use of degeneration resistors 632, 634, and 636, the current balancing between distributed transistors does not depend as much on the transistors matching, but instead on the resistors matching, and resistors usually match better than transistors (e.g. 100× better in one example). The number of distributed FETs in pass FET 521 and RCP circuit 525 will be equal in most cases. However, it is possible for the number of distributed FETs in pass FET 521 and RCP circuit 525 to be different.

Amplifier 508 receives a feedback voltage V_{FB} 512 at its inverting input, and receives a reference voltage V_{BG} 510 at its noninverting input. The reference voltage V_{BG} 510 is equal to the voltage that the feedback voltage V_{FB} 512 is when the LDO is regulating the voltage at the output voltage terminal V_{OUT} 550 to its nominal value. The output of amplifier 508 is an error voltage equal to the difference between the feedback voltage V_{FB} 512 and the reference voltage V_{BG} 510 multiplied by the gain of amplifier 508. The error voltage is provided to the input of super source follower circuit 503. The output of super source follower circuit 503 is provided to the input of pass FET 521. The output of pass FET 521 is provided to RCP circuit 525 which sources the current at the regulated voltage to the output voltage terminal V_{OUT} 550. Resistor 552 is an external resistor and/or a series resistance of capacitor 554, which provides filtering of the output voltage signal that is provided to load R_{L} 556.

RCP circuit 525 is controlled by the signal RCP_FET 574 which is provided as an output of the RCP control circuit 560. Comparator 562 compares the voltage at the input voltage terminal V_{IN} 502 to the voltage at the output voltage terminal V_{OUT} 550 and provides a logic high signal to the first input of AND logic circuit 572 as long as the voltage at the input voltage terminal V_{IN} 502 is higher than the voltage at the output voltage terminal V_{OUT} 550. Comparator 568 compares the difference between the voltage at the input voltage terminal V_{IN} 502 and the voltage at the output voltage terminal V_{OUT} 550 to a threshold voltage 564, which is at 10V in this case, and provides a logic high signal to the second input of AND logic circuit 572 as long as the difference between the voltage at the input voltage terminal V_{IN} 502 and the voltage at the output voltage terminal V_{OUT} 550 is less than the threshold voltage 564.

Additionally, the output of comparator 568 provides a signal Φ1 570 that closes switches 532 and 538 shorting the bulk to source of RCP FETs 530 and 542, respectively, if the difference between the voltages at the input voltage terminal V_{IN} 502 and the output voltage terminal V_{OUT} 550 is less than the threshold voltage 564. If the difference between the voltages at the input voltage terminal V_{IN} 502 and the output voltage terminal V_{OUT} 550 is greater than the threshold voltage 564, signal Φ1 570 opens switches 532 and 538, which connects resistor R DEG1 534 and resistor R_{DEG2} 536, respectively between the bulk and source of RCP FETs 530 and 542, respectively.

Opening switches 532 and 538 provides a voltage drop across degeneration resistors R_{DEG1} 534 and R_{DEG2} 536, reducing the voltage between the gate and source (V_{GS}) of pass FET M_{PASS1} 522 and M_{PASS2} 524, respectively, in proportion to the current through pass FETs 522 and 524. This provides negative current feedback that helps to keep RCP circuit 525 operating within its safe operating area.

The opening and closing of switch 532 and switch 538 can lead to switching effects on the signal at the output voltage terminal V_{OUT} 550. These switching effects can cause hundreds of mV of overshoot and undershoot on the output voltage during the switching, which may be undesirable for many applications.

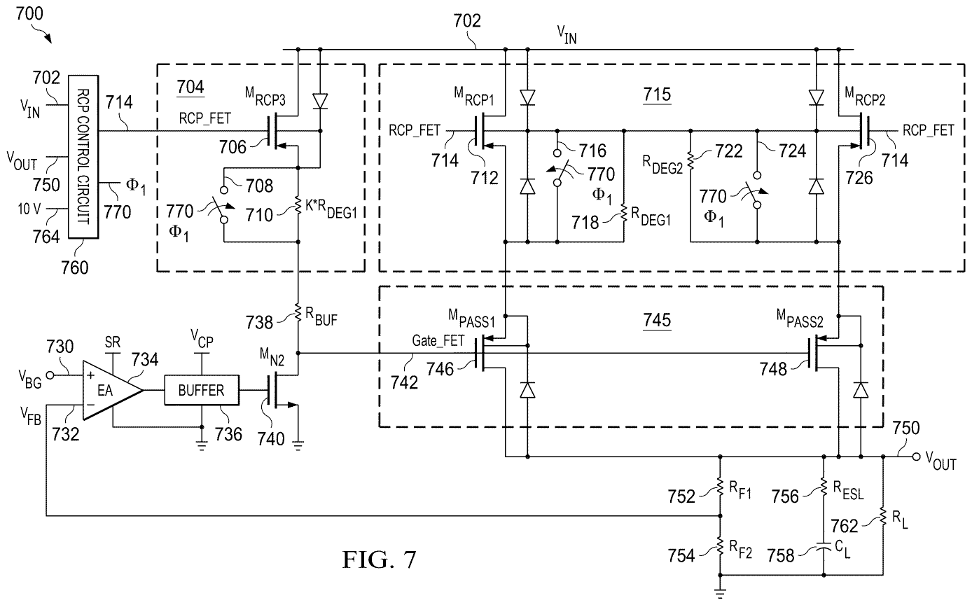

FIG. 7 shows a schematic diagram for an example LDO circuit 700 having RCP protection, using degeneration, and having a smooth switching circuit 704 to help counteract switching effects. LDO circuit 700 includes RCP control circuit 760, smooth switching circuit 704, RCP circuit 715, amplifier 734, buffer circuit 736, transistor M_{N2} 740, pass FET 745, feedback voltage divider resistors 752 and 754, and capacitor 758. RCP control circuit 760 has a first input coupled to an input voltage terminal V_{IN} 702 and has a second input coupled to the output voltage terminal V_{OUT} 750. A third input of RCP control circuit 760 is coupled to a threshold voltage terminal 764, which in at least one case is a 10V voltage source, but could be at a different voltage in other cases. RCP control circuit 760 is analogous to RCP control circuit 560 and performs the same functions.

A first output of RCP control circuit 760 is coupled to the input of smooth switching circuit 704. Smooth switching circuit 704 includes transistor M_{RCP3} 706 which has a drain coupled to the input voltage terminal V_{IN} 702. In at least one example, transistor M_{RCP3} 706 is a p-channel FET. However, in other examples, transistor M_{RCP3} 706 may instead be an n-channel FET. The source of transistor M_{RCP3} 706 is coupled to a first terminal of resistor 710, which has a resistance equal to K times the resistance of degeneration resistor R_{DEG1} 718 where K is the ratio of currents through pass FET 745 and transistor M_{N2} 740. Switch 708 is connected in parallel with resistor 710 and is controlled by a signal Φ1 770 provided by a second output of RCP control circuit 760.

The output of RCP control circuit 760 is coupled to the control terminal of RCP circuit 715, which includes distributed FETs M_{RCP1} 712 and M_{RCP2} 726. In at least one case, FETs M_{RCP1} 712 and M_{RCP2} 726 are p-channel FETs, but could be n-channel FETs in other cases. The drains of transistor M_{RCP1} 712 and transistor M_{RCP2} 726 are each coupled to the input voltage terminal V_{IN} 702. The source of transistor M_{RCP1} 712 is coupled to the source of FET M_{PASS1} 746, and the source of transistor M_{RCP2} 726 is coupled to the source of FET M_{PASS2} 748. The gates of transistor M_{RCP1} 712 and transistor M_{RCP2} 726 are each coupled to the first output of logic circuit 572, which provides the signal RCP_FET 714.

Transistor M_{RCP1} 712 has a first inherent parasitic diode between its bulk and its source and a second inherent parasitic diode between its bulk and its drain. Transistor M_{RCP2} 726 has a first inherent parasitic diode between its bulk and its source and a second inherent parasitic diode between its bulk and its drain. Switch 716 is coupled between the bulk and the source of transistor M_{RCP1} 712 and is controlled by the signal Φ1 770 provided by the second output of RCP control circuit 760. Degeneration resistor R_{DEG1} 718 is coupled in parallel with switch 716. Switch 724 is coupled between the bulk and the source of transistor M_{RCP2} 726 and is controlled by the signal Φ1 770. Degeneration resistor R_{DEG2} 722 is coupled in parallel with switch 724.

Amplifier 734 has a first input coupled to a voltage reference source V_{BG} 730. A second input of amplifier 734 is coupled to a feedback voltage terminal V_{FB} 732. The output of amplifier 734 is coupled to the input of buffer circuit 736. Buffer circuit 736 can be a unity gain amplifier having an analog voltage input and an analog voltage output. In at least one case, buffer circuit 736 provides an adaptive bias current to the gate of transistor M_{N2} 740 that adaptively changes with and is proportional to a load current provided at the output voltage terminal V_{OUT} 750. The output of buffer circuit 736 is coupled to the gate of transistor M_{N2} 740. Transistor M_{N2} 740 has a source coupled to a ground terminal and a drain coupled to the gate of pass FET 745. Resistor R_{BUF} 738 is coupled between resistor 710 and the gate of pass FET 745. Pass FET 745 is analogous to pass FET 521 and performs a similar function.

Pass FET 745 includes distributed FETs M_{PASS1} 746 and M_{PASS2} 748, and RCP circuit 715 is comprised of distributed FETs M_{RCP1} 712 and M_{RCP2} 726. RCP circuit 715 is analogous to RCP circuit 525 and performs essentially the same function. Distribution of FETs can help to provide improvement in the SOA of a FET. Distribution is distributing a single larger FET into N smaller FETs wherein each smaller FET has an area 1/N times the area of the larger FET. The respective sources and drains of each of the smaller FETs are connected together to effectively form a single FET unit from the multiple separate FET units. The number of distributed FETs in pass FET 745 and RCP circuit 715 will be equal in most cases. However, it is possible for the number of distributed FETs included in pass FET 745 and RCP circuit 715 to be different.

RCP circuit 715 is controlled by the signal RCP_FET 714 which is provided as an output of the RCP control circuit 760. RCP control circuit 760 compares the voltage at the input voltage terminal V_{IN} 702 to the voltage at the output voltage terminal V_{OUT} 750, and compares the difference between the voltage at the input voltage terminal V_{IN} 702 and the voltage at the output voltage terminal V_{OUT} 750 to a threshold voltage (e.g. 10V) and provides two output signals, RCP_FET 714 and Φ1 770, which closes switches 716 and 724 shorting the bulk to source of RCP FETs 712 and 726, respectively, if the difference between the voltage at the input voltage terminal V_{IN} 702 and the output voltage terminal V_{OUT} 750 is less than the threshold voltage. If the difference between the voltage at the input voltage terminal V_{IN} 702 and the voltage at the output voltage terminal V_{OUT} 750 is greater than the threshold voltage, signal Φ1 770 opens switches 716 and 724, connecting resistors R_{DEG1} 718 and R_{DEG2} 722 between the bulk and source of RCP FETs 712 and 726, respectively.

The signal Φ1 770 also controls opening and closing switch 708 in smooth switching circuit 704. Noise due to switching can appear at the output voltage terminal V_{OUT} 750 if the switching noise is propagated to the source of pass FET 745. This noise problem can be mitigated if any jumps or disturbances in the voltage present at the source of pass FET 745 are also present at the gate of pass FET 745. Smooth switching circuit 704 decreases the switching noise effects on the voltage at the output voltage terminal V_{OUT} 750 by emulating any voltage jumps or disturbances due to opening and closing switches 716 and 724, which are transmitted to the source of pass FET 745, and synchronously injecting the emulated voltage jumps into the gate of pass FET 745 so that the net effect on the V_{GS} of pass FET 745 is zero. Smooth switching circuit 704 may be optionally included in LDO circuit 500 by coupling the gate of transistor M_{RCP3} 706 to the output of logic circuit 572, coupling the drain of transistor M_{RCP3} 706 to the input voltage terminal V_{IN} 502, coupling the parallel combination of switch 708 and resistor 710 to the gate of transistor M_{PASS1} 522.

Switch 708 is connected in parallel with resistor 710, which is a scaled resistance of resistors R_{DEG1} 718 and R_{DEG2} 722. Switch 708 is controlled by the same signal that control switches 716 and 724. So, switch 708 opens and closes synchronously with switches 716 and 724. The same magnitude switching noise transmitted to the source of pass FET 745 from RCP circuit 715 is also transmitted to the gate of pass FET 745. The noise created by switches 716 and 724 is effectively cancelled out from the V_{GS} of pass FET 745 because it is present at both the gate and the source of pass FET 745, thus minimizing the effect on the output voltage signal of switching in the degeneration resistor circuit.

In this description, “terminal,” “node,” “interconnection,” “lead” and “pin” are used interchangeably. Unless specifically stated to the contrary, these terms generally mean an interconnection between or a terminus of a device element, a circuit element, an integrated circuit, a device, or other electronics or semiconductor component.

In this description, “ground” includes a chassis ground, an Earth ground, a floating ground, a virtual ground, a digital ground, a common ground and/or any other form of ground connection applicable to, or suitable for, the teachings of this description.

In this description, the term “couple” may cover connections, communications or signal paths that enable a functional relationship consistent with this description. For example, if device A generates a signal to control device B to perform an action, then: (a) in a first example, device A is coupled to device B by direct connection; or (b) in a second example, device A is coupled to device B through intervening component C if intervening component C does not alter the functional relationship between device A and device B, so device B is controlled by device A via the control signal generated by device A.

In this description, even if operations are described in a particular order, some operations may be optional, and the operations are not necessarily required to be performed in that particular order to achieve specified results. In some examples, multitasking and parallel processing may be advantageous. Moreover, a separation of various system components in the embodiments described above does not necessarily require such separation in all embodiments.

Modifications are possible in the described embodiments, and other embodiments are possible, within the scope of the claims.

What is claimed is:

1. A circuit comprising:
a control circuit having first and second outputs;
a first transistor having a terminal;
a second transistor having a terminal, a bulk, and a control terminal, the terminal of the second transistor is coupled to the terminal of the first transistor, the first and second transistors are coupled in series between an input voltage terminal of the circuit and an output voltage terminal of the circuit, and the control terminal is coupled to the first output of the control circuit;
a switch having first and second terminals and a control terminal, the first terminal is coupled to the terminal of the second transistor, the second terminal is coupled to the bulk, the control terminal of the switch is coupled to the second output of the control circuit; and
a resistor having first and second terminals, the first terminal of the resistor is coupled to the terminal of the second transistor, and the second terminal of the resistor is coupled to the bulk.

2. The circuit of claim 1, wherein the control circuit has a first input coupled to the input voltage terminal and a second input coupled to the output voltage terminal, and the control circuit is capable of closing the switch responsive to a difference between a voltage at the input voltage terminal and a voltage at the output voltage terminal exceeding a threshold.

3. The circuit of claim 2, wherein the control circuit includes:
a first comparator having first and second inputs and an output, the first input is coupled to the input voltage terminal, and the second input is coupled to the output voltage terminal;
a second comparator having an output and capable of comparing the difference between the voltage at the input voltage terminal and the voltage at the output voltage terminal to the threshold; and
a logic circuit having first and second inputs and an output, the first input of the logic circuit is coupled to the output of the first comparator, the second input of the logic circuit is coupled to the output of the second comparator, and the output of the logic circuit is coupled to the control terminal of the second transistor.

4. The circuit of claim 1, wherein the switch is a first switch, the resistor is a first resistor, and the terminal of the second transistor is a first terminal, the circuit further comprising:
a third transistor having first and second terminals, a bulk, and a control terminal, the second terminal of the third transistor is coupled to the second terminal of the second transistor, and the control terminal of the third transistor is coupled to the first output of the control circuit;
a second switch having first and second terminals, the first terminal of the second switch is coupled to the first terminal of the third transistor, the second terminal of the second switch is coupled to the bulk of the third transistor, and the control terminal of the second switch is coupled to the second output of the control circuit; and
a second resistor having first and second terminals, the first terminal of the second resistor is coupled to the terminal of the third transistor, and the second terminal of the second resistor is coupled to the bulk of the third transistor.

5. The circuit of claim 4, wherein the terminal of the first transistor is a first terminal, and the first transistor has a second terminal and a control terminal, and the circuit further comprising a fourth transistor having a first terminal coupled to the first terminal of the third transistor, a second terminal coupled to the second terminal of the first transistor, and a control terminal coupled to the control terminal of the first transistor.

6. The circuit of claim 1, wherein the terminals of the first and second transistors are first terminals, the first transistor has a second terminal coupled to the voltage input terminal, and the second transistor has a second terminal coupled to the voltage output terminal.

7. The circuit of claim 1, wherein the terminals of the first and second transistors are first terminals, the first transistor has a second terminal coupled to the voltage output terminal, and the second transistor has a second terminal coupled to the voltage input terminal.

8. The circuit of claim 1, wherein the first transistor has a control terminal, and the circuit further comprising an amplifier having a reference input, a second input coupled to the voltage output terminal, and an output coupled to the control terminal of the first transistor.

9. A circuit, comprising:
an amplifier having a reference input, a second input, and an output, the second input is coupled to an output voltage terminal of the circuit;
a control circuit having first and second inputs and first and second outputs, the first input of the control circuit is coupled to an input voltage terminal of the circuit, and the second input of the control circuit is coupled to the output voltage terminal;
a first transistor having first and second terminals and a control terminal, the first terminal is coupled to the input voltage terminal, and the control terminal is coupled to the output of the amplifier;
a second transistor having first and second terminals, a bulk, and a control terminal, the first terminal is coupled to the second terminal of the first transistor, the second terminal is coupled to the output voltage terminal, and the control terminal is coupled to the first output of the control circuit;
a third transistor having first and second terminals, a bulk, and a control terminal, the second terminal of the third transistor is coupled to the output voltage terminal, and the control terminal of the third transistor is coupled to the first output of the control circuit;
a first switch having first and second terminals and a control terminal, the first terminal of the first switch is coupled to the first terminal of the second transistor, the second terminal of the first switch is coupled to the bulk of the second transistor, the control terminal of the first switch is coupled to the second output of the control circuit;
a second switch having first and second terminals and a control terminal, the first terminal of the second switch is coupled to the first terminal of the third transistor, the second terminal of the second switch is coupled to the bulk of the third transistor, the control terminal of the second switch is coupled to the second output of the control circuit;
a first resistor having first and second terminals, the first terminal of the first resistor is coupled to the first terminal of the second transistor, and the second terminal of the first resistor is coupled to the bulk of the second transistor; and
a second resistor having first and second terminals, the first terminal of the second resistor is coupled to the first terminal of the third transistor, and the second terminal of the second resistor is coupled to the bulk of the third transistor.

10. The circuit of claim 9, further comprising a fourth transistor having first and second terminals, the first terminal is coupled to the input voltage terminal, the second terminal is coupled to the first terminal of the third transistor, and the control terminal is coupled to the output of the amplifier.

11. The circuit of claim 9, wherein the first and second switches close in response to a difference voltage that is equal to a difference between a voltage at the input voltage terminal of the circuit and a voltage at the output voltage terminal of the circuit being greater than a voltage at a threshold voltage terminal.

12. The circuit of claim 11, wherein the control circuit includes:
a first comparator having first and second inputs and an output, the first input is coupled to the input voltage terminal of the circuit, and the second input is coupled to the output voltage terminal of the circuit;
a second comparator having first and second inputs and an output, the first input is coupled to a threshold voltage terminal, and the second input is coupled to a terminal that provides the difference voltage; and
a logic circuit having first and second inputs and an output, the first input is coupled to the output of the first comparator, the second input is coupled to the output of the second comparator, and the output is coupled to the control terminal of the second transistor.

13. The circuit of claim 12, wherein the logic circuit includes an AND gate.

14. The circuit of claim 9, further comprising:
a buffer circuit having an input and an output, the input coupled to the output of the amplifier;
a fourth transistor having first and second terminals and a control terminal, the first terminal coupled to the control terminal of the first transistor, and the control terminal of the fourth transistor coupled to the output of the buffer circuit;
a current source having first and second terminals, the second terminal coupled to the control terminal of the first transistor; and
a diode having first and second terminals, the first terminal coupled to the first terminal of the current source, the second terminal coupled to the second terminal of the current source.

15. The circuit of claim 9, further comprising:
a fourth transistor having first and second terminals, a bulk and a control terminal, the control terminal coupled to the first output of the control circuit, and the first terminal of the fourth transistor coupled to the input voltage terminal;
a third switch having first and second terminals and a control terminal, the first terminal coupled to the bulk of the fourth transistor, the second terminal coupled to the control terminal of the first transistor, and the control terminal of the third switch coupled to the second output of the control circuit; and
a third resistor having first and second terminals, the first terminal coupled to the first terminal of the third switch, and the second terminal coupled to the second terminal of the third switch.

16. A circuit, comprising:
an amplifier having first and second inputs and an output, the first input is coupled to a feedback voltage terminal, and the second input is coupled to a reference voltage terminal;
a buffer circuit having an input and an output, the input is coupled to the output of the amplifier;
a control circuit having first and second inputs and first and second outputs, the first input is coupled to an input voltage terminal of the circuit, and the second input is coupled to an output voltage terminal of the circuit;
a first transistor having first and second terminals and a control terminal, the first terminal is coupled to the output voltage terminal of the circuit, and the control terminal is coupled to the output of the buffer circuit;
a second transistor having first and second terminals, a bulk, and a control terminal, the first terminal is coupled to the second terminal of the first transistor, the second terminal is coupled to the input voltage terminal of the circuit, and the control terminal is coupled to the first output of the control circuit;
a switch coupled between the first terminal of the second transistor and the bulk and having a control terminal coupled to the second output of the control circuit; and
a resistor coupled between the first terminal of the second transistor and the bulk.

17. The circuit of claim 16, further comprising a third transistor having first and second terminals, the first terminal is coupled to the output voltage terminal, the second terminal is coupled to the first terminal of the first transistor, and the control terminal is coupled to the output of the buffer circuit.

18. The circuit of claim 16, wherein the switch closes in response to a difference voltage that is equal to a difference between a voltage at the input voltage terminal of the circuit and a voltage at the output voltage terminal of the circuit being greater than a voltage at a threshold voltage terminal.

19. The circuit of claim 18, wherein the control circuit includes:
a first comparator having first and second inputs and an output, the first input is coupled to the input voltage terminal of the circuit, and the second input is coupled to the output voltage terminal of the circuit;
a second comparator having first and second inputs and an output, the first input is coupled to a threshold voltage terminal, and the second input is coupled to a terminal that provides the difference voltage; and
a logic circuit having first and second inputs and an output, the first input is coupled to the output of the first comparator, the second input is coupled to the output of the second comparator, and the output is coupled to the control terminal of the second transistor.

20. The circuit of claim 19, wherein the logic circuit includes an AND gate.

21. The circuit of claim 16, further comprising:
a third transistor having first and second terminals and a control terminal, the first terminal coupled to the control terminal of the first transistor, and the control terminal of the third transistor coupled to the output of the buffer circuit;
a current source having first and second terminals, the second terminal coupled to the control terminal of the first transistor; and
a diode having first and second terminals, the first terminal coupled to the first terminal of the current source, the second terminal coupled to the second terminal of the current source.

22. The circuit of claim 16, further comprising:
a third transistor having first and second terminals, a bulk and a control terminal, the control terminal coupled to the first output of the control circuit, and the first terminal of the third transistor coupled to the input voltage terminal;
a second switch having first and second terminals and a control terminal, the first terminal coupled to the bulk of the third transistor, the second terminal coupled to the control terminal of the first transistor, and the control terminal of the second switch coupled to the second output of the control circuit; and
a second resistor having first and second terminals, the first terminal coupled to the first terminal of the second switch, and the second terminal coupled to the second terminal of the second switch.
